(19) United States
(12) Patent Application Publication
(10) Pub. No.: US 2023/0272143 A1
(43) Pub. Date: Aug. 31, 2023

(54) SURFACE TREATMENT LIQUID AND HYDROPHILIZING TREATMENT METHOD

(71) Applicant: TOKYO OHKA KOGYO CO., LTD., Kanagawa (JP)

(72) Inventor: Takahiro SENZAKI, Kanagawa (JP)

(21) Appl. No.: 18/042,843

(22) PCT Filed: Jul. 28, 2021
(86) PCT No.: PCT/JP2021/027980

§ 371 Date: Feb. 24, 2023

(30) Foreign Application Priority Data
Aug. 27, 2020 (JP) 2020-143885

(51) Int. Cl. C08F 236/20; C08F 226/06; C09D 147/00; C09D 139/04

(52) U.S. Cl. CPC C08F 236/20; C08F 226/06; C09D 147/00; C09D 139/04

(57) ABSTRACT

A surface treatment liquid capable of forming a hydrophilic resinous coating film adhering well to a surface of an object to be surface-treated and providing a surface treatment effect that does not decrease over time, even when the surface-treated article is exposed to a variety of agents, and a surface treatment method using the surface treatment liquid is provided.

A surface treatment liquid including a polymerizable compound (A), a thermal polymerization initiator (B), and a solvent (S),
in which the polymerizable compound (A) includes a betaine monomer (a1) having a group including an ethylenic unsaturated double bond, an anionic group, and a cationic group, an unsaturated group-containing silicon compound (a2) having a group including an ethylenic unsaturated double bond, and a hydrolyzable silyl group, and/or a polar polymerizable compound (a3) having an ethylenic unsaturated double bond, and a polar group selected from amino group, carboxylic group, mercapto group, hydroxy group, and cyano group is used.

### TECHNICAL FIELD

The present invention relates to a surface treatment liquid and a hydrophilizing treatment method in which the surface treatment liquid is used.

### BACKGROUND ART

In order to modify the properties of surfaces of a variety of articles, surface treatments have been thus far carried out using a variety of surface treatment liquids. As surface modification, particularly, hydrophilization of the surfaces of articles has been significantly demanded, and a number of chemicals and surface treatment liquids for hydrophilization have been proposed. A surface treatment of an object using a chemical or surface treatment liquid for hydrophilization forms a coating on the surface of the object and hydrophilizes the surface of the object.

As such chemicals and surface treatment liquids for hydrophilization, for example, a hydrophilizing treatment agent including a copolymer of monomer including at least acrylamide monomer and mono(meth)acrylate monomer as a component for hydrophilic property (refer to Patent Document 1) and a hydrophilizing treatment agent containing a block copolymer including a polyvinyl alcohol resin block having mercapto group and a polyanionic resin block, and polyacrylic acid (refer to Patent Document 2) have been proposed. The polyanionic resin block disclosed in Patent Document 2 is a block in which a polymerizable monomer having at least one carboxylic group and/or sulfonic acid group in one molecule is polymerized.

### Patent Document 1: Japanese Patent No. 5437523

### Patent Document 2: Japanese Unexamined Patent Application, Publication No. 2009-126948

### DISCLOSURE OF THE INVENTION

### Problems to be Solved by the Invention

However, adhesiveness of resins as hydrophilizing component included in the hydrophilizing treatment agents disclosed in Patent Document 1 and Patent Document 2 to the surface of object to be treated is not necessarily sufficient. As a result, with respect to conventional hydrophilizing treatment agent, there are problems that there is a case that it is difficult to obtain sufficient hydrophilizing effect, and hydrophilizing effect easily decrease due to peeling of the resin from the surface of the object to be treated.

In addition, for example, there is a case that the object to be surface-treated such as windows and mirrors are exposed to chemicals such as cleaning agent used for cleaning. In particular, windows and mirrors used in wet areas are often exposed to acidic detergents used to remove water stains and basic detergents used to remove mold. In addition, regardless of pH of the detergent, various detergents including soaps and shampoos also include various ionic surfactants such as sodium salt of fatty acid, sodium dodecyl sulfate (SDS), and sodium linear alkyl ether sulfonate. Furthermore, there is a case that detergents include organic acids and organic based such as oleic acid, behenic acid, dimethyl stearylamine, and dimethyl coconutamine capable of forming anions or cations having a hydrophobic part.

However, regarding articles surface-treated with the conventional hydrophilizing treatment agent described in Patent Document 1, a problem is that, when the articles are exposed to detergents including an acid, an alkali, a variety of ionic surfactants, an organic acid or organic base capable of generating an anion or cation having a hydrophobic portion or the like, the hydrophilicity on the surfaces of the surface-treated articles may gradually deteriorate over time.

The present invention has been made in consideration of the above-described problem, and an objective of the present invention is to provide a surface treatment liquid capable of forming a hydrophilic resinous coating film adhering well to a surface of an object to be surface-treated and providing a surface treatment effect that does not decrease over time, even when the surface-treated article is exposed to a variety of agents, and a surface treatment method using the surface treatment liquid.

### Means for Solving the Problems

The present inventors found that it was possible to solve the above-mentioned problem by a surface treatment liquid including a polymerizable compound (A), a thermal polymerization initiator (B), and a solvent (S), in which the polymerizable compound (A) includes a betaine monomer (a1) having a group including an ethylenic unsaturated double bond, an anionic group, and a cationic group, an unsaturated group-containing silicon compound (a2) having a group including an ethylenic unsaturated double bond, and a hydrolyzable silyl group, and/or a polar polymerizable compound (a3) having an ethylenic unsaturated double bond, and a polar group selected from amino group, carboxylic group, mercapto group, hydroxy group, and cyano group. In more detail, the present invention provides the followings.

A first aspect of the present invention is a surface treatment liquid including a polymerizable compound (A), a thermal polymerization initiator (B), and a solvent (S), in which the polymerizable compound (A) includes a betaine monomer (a1) having a group including an ethylenic unsaturated double bond, an anionic group, and a cationic group, an unsaturated group-containing silicon compound (a2) having a group including an ethylenic unsaturated double bond, and a hydrolyzable silyl group, and/or a polar polymerizable compound (a3) having an ethylenic unsaturated double bond, and a polar group selected from amino group, carboxylic group, mercapto group, hydroxy group, and cyano group.

A second aspect of the present invention is a hydrophilizing treatment method for hydrophilizing a surface of the object to be treated, including:
forming a coating film on the surface of the object to be treated by applying the surface treatment liquid according to the first aspect, and
heating the coating film.

### Effects of the Invention

According to the present invention, it is possible to provide a surface treatment liquid which can form a hydrophilic resinous coating film on the surface of the object to be surface-treated, and achieves a surface treatment effect that does not decrease over time, even when the surface-treated articles are exposed to various chemicals, and a surface treatment method using the surface treatment liquid.

### PREFERRED MODE FOR CARRYING OUT THE INVENTION

### «Surface Treatment Liquid»

A surface treatment liquid includes a polymerizable compound (A), a thermal polymerization initiator (B), and a solvent (S). Such surface treatment liquid can hydrophilize a surface of an object to be surface-treated. Hereinafter, with respect to the surface treatment liquid, essential components and optional components, and the like will be described in detail.

### <Polymerizable Compound (A)>

The polymerizable compound (A) polymerize by an action of the thermal polymerization initiator (B) on the surface of the object to be treated to form a resinous coating film adhering well to the surface of the object to be treated. The polymerizable compound (A) includes a betaine monomer (a1) having a group including an ethylenic unsaturated double bond, an anionic group, and a cationic group, an unsaturated group-containing silicon compound (a2) having a group including an ethylenic unsaturated double bond, and a hydrolyzable silyl group, and/or a polar polymerizable compound (a3) having an ethylenic unsaturated double bond, and a polar group selected from amino group, carboxylic group, mercapto group, hydroxy group, and cyano group. In addition, the polymerizable compound (A) may include a polyfunctional monomer (a4), other monomer (a5), and the like other than the betaine monomer (a1), the unsaturated group-containing silicon compound, and the polar polymerizable compound (a3) described above. By inclusion of the unsaturated group-containing silicon compound (a2) which has a group including ethylenic unsaturated double bond and a hydrolyzable silyl group, and/or the polar polymerizable compound (a3) which has a group including a ethylenic unsaturated double bond and a polar group selected from amino group, carboxylic group, mercapto group, hydroxy group, and cyano group, in surface treatment, it is thought that these compounds firmly bond to the surface of the object to be treated, and polymerization reaction of the polymerizable compound (A) proceeds in the vicinity of the surface of the object to be treated from these compounds bound to the surface of the object to be treated as starting point. In this way, it is believed that a thin coating film consisting of a polymer of the polymerizable compound (A) firmly bonded to the surface of the object to be treated is conveniently formed.

[Betaine Monomer (a1)]

The polymerizable compound (A) include a betaine monomer having a cationic group, an anionic group, and a group having an ethylenic unsaturated double bond. Both of the cationic group and the anionic group act as the hydrophilic group. There is a case that the surface-treated surface of the object to be treated comes into contact with a cleaning liquid including a large amount of anions with hydrophobic groups or cations with hydrophobic groups. In a case where a resin in the surface treatment liquid has only an anionic group such as a carboxy group, a carboxylate group, a sulfonic acid group or a sulfonate group as the hydrophilic group, this hydrophilic group may stop acting as a hydrophilic group due to an interaction with a cation having a hydrophobic group. In addition, in a case where the resin in the surface treatment liquid has only a cationic group such as a quaternary ammonium group as the hydrophilic group, the cationic group may stop acting as a hydrophilic group due to an interaction with an anion having a hydrophobic group. However, in case that the polymer of the polymerizable compound (A) including the betaine monomer (a1) has both of the cationic group and the anionic group as the hydrophilic group, an action as the hydrophilic group of any one of the cationic group and the anionic group can be maintained, and hydrophobicity of the surface of the object to be treated is hardly decrease, when the surface-treated surface of the object to be treated comes into contact with a cleaning agent including a large amount of cations having hydrophobic groups or cleaning agent including a large amount of anions having the hydrophobic group.

A number of the cationic group and a number of the anionic group in the betaine monomer (a1) are not particularly limited. The number of the cationic group and the number of the anionic group in the betaine monomer (a1) are preferably the same. The number of the cationic groups and the number of the anionic groups in the polymerizable betaine monomer (a1) are each preferably one since the synthesis or procurement of the polymerizable betaine monomer (a1) is easy.

In the betaine monomer (a1), for example, a group having the ethylenic double bond, the cationic group, and the cationic group are preferably bonded, if necessary, via a bridging group, in this order.

The cationic group is preferably a cationic group that is a quaternary nitrogen cation. The anionic group is preferably sulfonic acid anion group, phosphonic acid anion group, or carboxylic acid anion group.

As the group having the ethylenic double bond in the betaine monomer (a1), alkenyl groups such as vinyl group, 1-propenyl group, 2-n-propenyl group (allyl group), 1-n-butenyl group, 2-n-butenyl group, and 3-n-butenyl group are exemplified. Among these groups, vinyl group and 2-n-propenyl group (ally group) are preferred. A number of the ethylenic double bond in the betaine monomer is not particularly limited, and preferably 1 or 2.

As the betaine monomer (a1), compounds represented by the following formula (a1-i) or formula (a1-ii) are preferred. The betaine monomers represented by the following formula (a1-i) or formula (a1-ii) include the cationic group including N+ and the anionic group as R. Both of the cationic group and the anionic group act as the hydrophilic group.

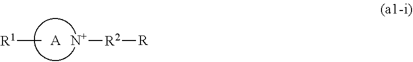

In the formula (a1-i), R¹ is a hydrocarbon group including an ethylenic unsaturated double bond. R² is a divalent hydrocarbon group having 1 or more and 10 or less carbon atoms. R is an anionic group. Ring A is a heterocycle.

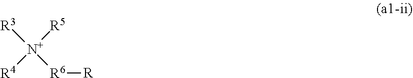

In the formula (a1-ii), R³, R⁴, and R⁵ are each independently a hydrocarbon group having the ethylenic double bond or a hydrocarbon group having 1 or more and 10 or less. At least one of R³, R⁴, and R⁵ are the hydrocarbon group having an ethylenic unsaturated double bond. R⁶ is a divalent hydrocarbon group having 1 or more and 10 or less carbon atoms. R is an anionic group.

In the formula (a1-i), as the hydrocarbon group including the ethylenic double bond as R¹, alkenyl groups such as vinyl group, 1-propenyl group, 2-n-propenyl group (allyl group), 1-n-butenyl group, 2-n-butenyl group, and 3-n-butenyl group are exemplified.

In the formula (a1-i), as the divalent hydrocarbon group as R², an alkylene group, an arylene group, and a group which is a combination of the alkylene group and the arylene group are preferred. Suitable specific examples of the alkylene group as R² include methylene group, ethane-1,2-diyl group, propane-1,3-diyl group, propane-1,2-diyl group, butane-1,4-diyl group, butane-1,4-diyl group, pentane-1,5-diyl group, hexane-1,6-diyl group, heptane-1,7-diyl group, octane-1,8-diyl group, nonane-1,9-diyl group, and decane-1,10-diyl group.

In the formula (a1-i), the heterocycle as ring A may be an aromatic heterocycle or an aliphatic heterocycle. As the aromatic heterocycle, a ring in which any one of the nitrogen atom(s) in a nitrogen-containing aromatic heterocycle such as imidazole ring, pyrazole ring, 1,2,3-triazole ring, 1,2,4-triazole ring, pyridine ring, pyrimidine ring, pyridazine ring, and pyrazine is quaternized is exemplified. As the aliphatic heterocycle, a ring in which any one of the nitrogen atom(s) in a nitrogen-containing heterocycle such as pyrrolidine ring, piperidine ring, and piperazine ring is quaternized is exemplified.

In the formula (a1-ii), as the hydrocarbon group including the ethylenic double bond as R³ to R⁵, alkenyl groups such as vinyl group, 1-propenyl group, 2-n-propenyl group (allyl group), 1-n-butenyl group, 2-n-butenyl group, and 3-n-butenyl group are exemplified.

In the formula (a1-ii), as the hydrocarbon group as R³ to R⁵, an alkyl group, an aryl group, and aralkyl group are exemplified, and alkyl group is preferred. The hydrocarbon group as R³ to R⁵ may have a substituent. The substituent which the hydrocarbon group as R³ to R⁵ may have is not particularly limited as long as the objective of the present invention is not impaired. Examples of the substituent include a halogen atom, a hydroxy group, an alkoxy group having 1 or more and 4 or less carbon atoms, an acyl group having 2 or more and 4 or less carbon atoms, an acyloxy group having 2 or more and 4 or less carbon atoms, an amino group, an alkylamino group substituted with one or two alkyl group having 1 or more and 4 or less carbon atoms, and the like. Suitable specific examples of the alkyl group as R³ to R⁵ include methyl group, ethyl group, n-propyl group, isopropyl group, n-butyl group, isobutyl group, sec-butyl group, tert-butyl group, n-pentyl group, n-hexyl group, n-heptyl group, n-octyl group, 2-ethylhexyl group, n-nonyl group, and n-decyl group.

In the formula (a1-ii), as the divalent hydrocarbon group as R⁶, an alkylene group, an arylene group, and a group which is a combination of the alkylene group and the arylene group are exemplified, and the alkylene group is preferred. Suitable specific examples of the alkylene group as R⁶ include methylene group, ethane-1,2-diyl group, propane-1,3-diyl group, propane-1,2-diyl group, butane-1,4-diyl group, butane-1,4-diyl group, pentane-1,5-diyl group, hexane-1,6-diyl group, heptane-1,7-diyl group, octane-1,8-diyl group, nonane-1,9-diyl group, and decane-1,10-diyl group.

As the betaine monomer which has the sulfonic acid anion group as the anionic group, in view of ease of synthesis and availability, monomers represented by the following formula (a1-iii) or the formula (a1-iv) are preferred.

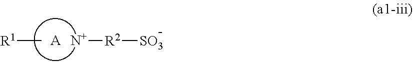

In the formula (a1-iii), R¹, R², and ring A are the same as R¹, R², and ring A in the formula (a1-i).

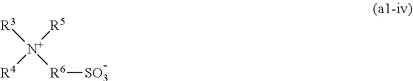

In the formula (a1-iv), R³, R⁴, R⁵, and R⁶ are the same as R³, R⁴, R⁵, and R⁶ in the formula (a1-ii).

As the monomers represented by the formula (ai-iii) or the formula (ai-iv), monomers represented by the following formula (a1-v), (a1-vi), or (a1-vii) are exemplified.

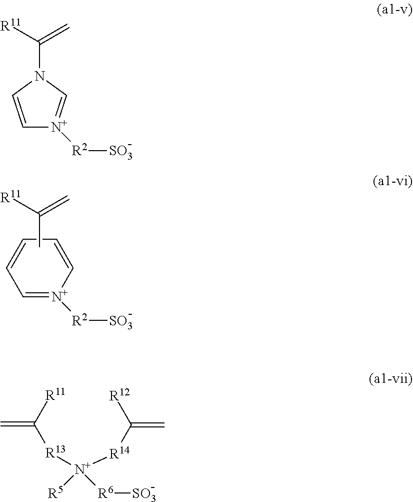

In the formula (a1-v), (a1-vi), and (a1-vii), R² is the same as R² in the formula (a1-iii). R⁵ and R⁶ are the same as R⁵ and R⁶ in the formula (a1-iv). R¹¹ and R¹² are each independently hydrogen atom or methyl group. R¹³ and R¹⁴ are each independently a single bond or an alkylene group having 1 or more and 4 or less carbon atoms.

In the formula (a1-v), (a1-vi), and (a1-vii), as the alkylene group having 1 or more and 4 or less carbon atoms as R¹³ and R¹⁴, methylene group, ethane-1,2-diyl group, propane-1,3-diyl group, propane-1,2-dyl group, and butane-1,4-diyl group are exemplified.

As the betaine monomers having the phosphonic acid anion group or the carboxylic acid anion group as the anionic group, monomers represented by the formula (a1-ii) or the formula (a1-iv) described above, and monomers which the sulfonic acid anion group (—SO₃⁻) is replaced with the phosphonic acid anion group (—(PO₃)²⁻) or the carboxylic acid anion group (—COO⁻) in the monomers represented by the formula (a1-vii) are exemplified.

Specific examples of the betaine monomer represented by the formula (a1-i) or the formula (a1-ii) include monomers which the sulfonic acid anion group (—SO₃⁻) is replaced with the phosphonic acid anion group (—(PO₃)²⁻) or the carboxylic acid anion group (—COO⁻) in the following compounds.

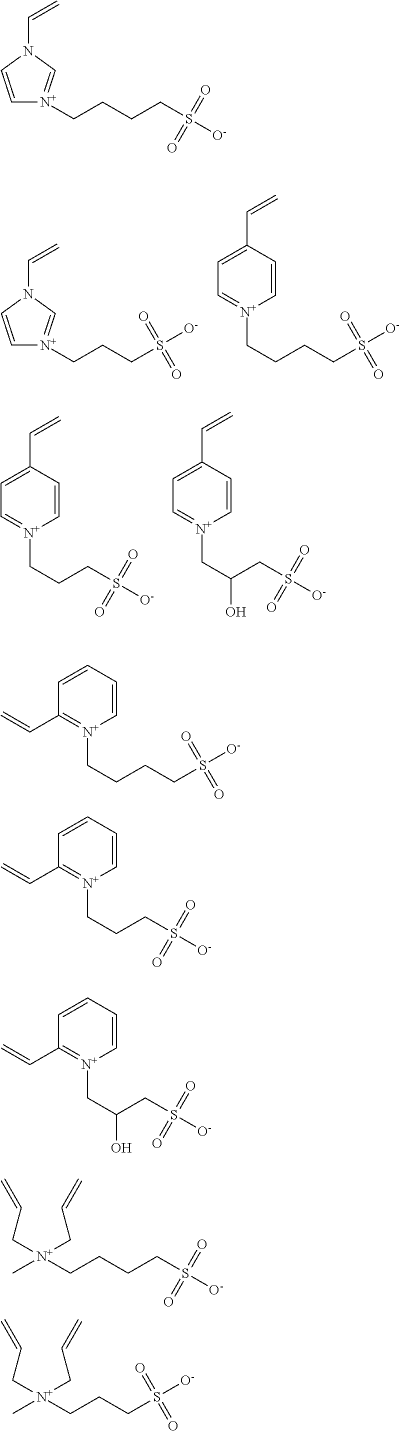

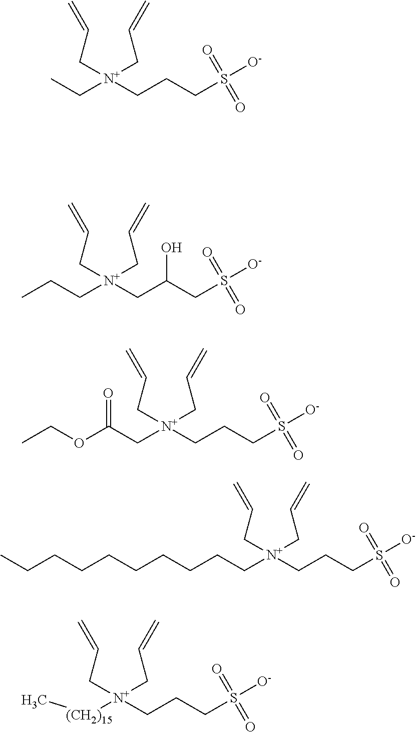

The betaine monomer represented by the formula (a1-i) or the formula (a1-ii) can be synthesized by known reactions. For example, the betaine monomer represented by the formula (a1-i) or the (a1-ii) can be obtained by reacting a compound having a group having the ethylenic unsaturated double bond and a group that can form the cationic group with a compound having the anionic group. Specifically, for example, a compound represented by the formula (a1-iii) is obtained by reacting the following compound with a sultone in a solvent. As the sultone, a sultone having 4-membered or more and 10-membered or less ring is exemplified, and 1,3-propane sultone, and 1,4-butane sultone are preferred.

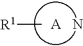

In the formula, R¹ is the same as R¹ in the (a1-i). Ring A is a heterocycle.

In addition, the compound represented by the formula (a1-viii) is also preferred as the betaine monomer (a1). The betaine monomer (a1) represented by the formula (a1-viii) includes a cationic group including N+ and the anionic group as R²⁰. Both of the cationic group and the anionic group act as the hydrophilic group.

CH₂═CR¹⁵—CO—NH—R¹⁶—N⁺(R¹⁷)(R¹⁸)—R¹⁹—R²⁰ (a1-viii)

In the formula (a1-viii), R¹⁵ is hydrogen atom or methyl group. R¹⁶ and R¹⁹ are each independently a divalent hydrocarbon group having 1 or more and 10 or less carbon atoms. R¹⁷ and R¹⁸ are each independently an optionally substituted hydrocarbon group having 1 or more and 10 or less carbon atoms. R²⁰ is sulfonic acid anion group (—SO₃⁻), phosphonic acid anion group (—(PO₃)₂⁻), or carboxylic acid anion group (—COO⁻).

In the formula (a1-viii), as the divalent hydrocarbon group as R¹⁶ and R¹⁹, an alkylene group, an arylene group, and a group which is a combination of the alkylene group and the arylene group are exemplified, and the alkylene group is preferred. Suitable specific examples of the alkylene group as R¹⁶ and R¹⁹ include methylene group, ethane-1,2-diyl group, propane-1,3-diyl group, propane-1,2-diyl group, butane-1,4-diyl group, butane-1,4-diyl group, pentane-1,5-diyl group, hexane-1,6-diyl group, heptane-1,7-diyl group, octane-1,8-diyl group, nonane-1,9-diyl group, and decane-1,10-diyl group.

In the formula (a1-viii), as the hydrocarbon group as R¹⁷ and R¹⁸, an alkyl group, an aryl group, and an aralkyl group are exemplified, and the alkyl group is preferred. The hydrocarbon group as R¹⁷ and R¹⁸ may have a substituent. The substituent which the hydrocarbon group as R¹⁷ and R¹⁸ may have is not particularly limited as long as the objective of the present invention is not impaired. Examples of the substituent include a halogen atom, a hydroxy group, an alkoxy group having 1 or more and 4 or less carbon atoms, an acyl group having 2 or more and 4 or less carbon atoms, an acyloxy group having 2 or more and 4 or less carbon atoms, an amino group, an alkylamino group substituted with one or two alkyl group having 1 or more and 4 or less carbon atoms, and the like. Suitable specific examples of the alkyl group as R¹⁷ and R¹⁸ include methyl group, ethyl group, n-propyl group, isopropyl group, n-butyl group, isobutyl group, sec-butyl group, tert-butyl group, n-pentyl group, n-hexyl group, n-heptyl group, n-octyl group, 2-ethylhexyl group, n-nonyl group, and n-decyl group.

In the formula (a1-viii), R²⁰ is sulfonic acid anion group (—SO₃⁻), phosphonic anion group (—PO₃²⁻) or carboxylic acid anion group (—COO⁻), and the sulfonic acid anion group (—SO₃⁻) is preferred.

Suitable examples of the compound represented by the formula (a1-viii) include the following compounds. In the following formulas, R¹⁵ is hydrogen atom or methyl group.

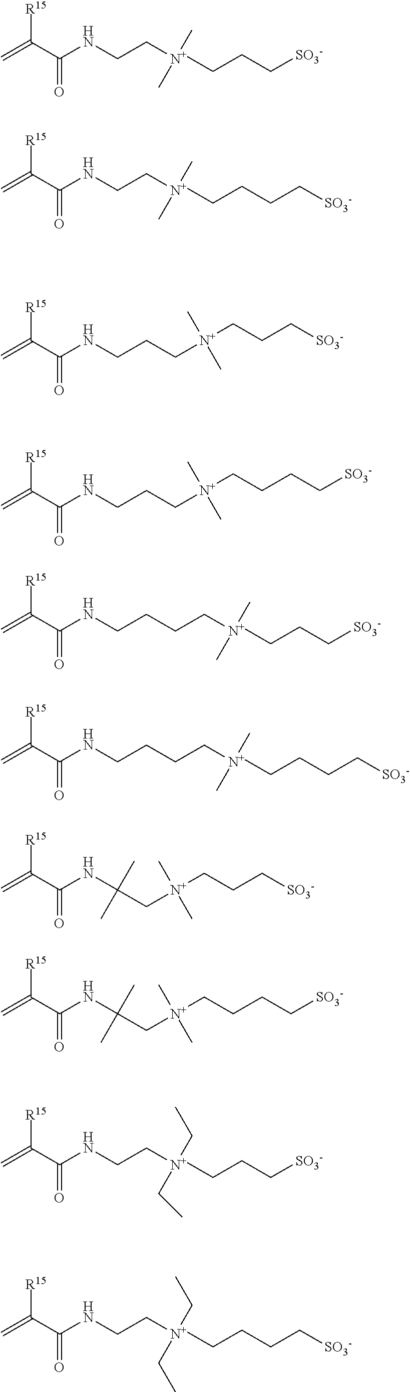

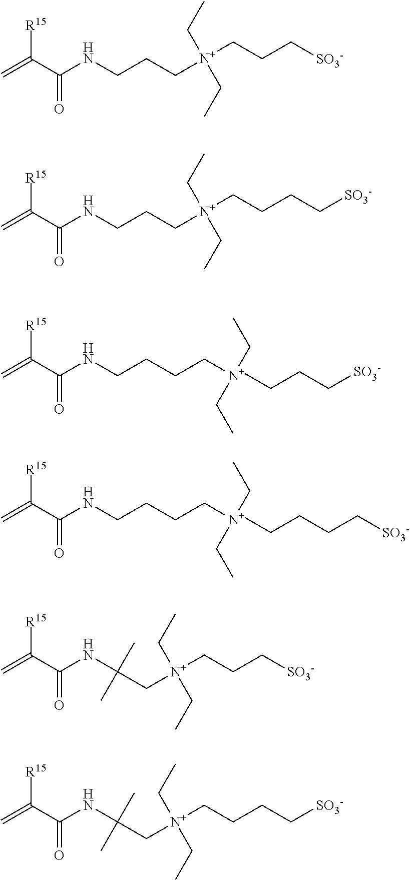

A content of the betaine monomer (a1) in the polymerizable compound (A) is not particularly limited as long as the objective of the present invention is not impaired. From the viewpoint of satisfying both a good hydrophilization effect and the good adhesiveness of the resin coating to be formed to the surface of the object to be treated, the ratio of the number of moles of the betaine monomer (a1) is preferably 50% by mole or more and 99% by mole or less, more preferably 60% by mole or more and 99% by mole or less, and even more preferably 70% by mole or more and 99% by mole or less relative to the number of moles of the polymerizable compound (A).

[Constituent Unit (a2) and Constituent Unit (a3)]

The polymerizable compound includes an unsaturated group-containing silicon compound (a2) having a group including an ethylenic unsaturated double bond and a hydrolyzable silyl group, and/or a polar polymerizable compound (a3) having a group including an ethylenic unsaturated double bond and a polar group selected from amino group, carboxy group, mercapto group, hydroxy group, and cyano group together with the aforementioned betaine monomer (a1).

Both of the unsaturated group-containing silicon compound (a2) and the polar polymerizable compound (a3) are constituent units giving the resin coating consisting of the polymer of the polymerizable compound (A) adhesiveness to the surface of the object to be treated.

(Unsaturated Group-Containing Silicon Compound (a2))

The unsaturated group-containing silicon compound (a2) has a group having an ethylenic unsaturated double bond and a hydrolyzable silyl group.

The group having the ethylenic unsaturated double bond is not particularly limited as long as the unsaturated group-containing silicon compound (a2) is polymerizable with the betaine monomer (a1). Suitable specific examples of the group having the ethylenic unsaturated double bond include alkenyl groups such as vinyl group, 1-propenyl group, 2-n-propenyl group (allyl group), 1-n-butenyl group, 2-n-butenyl group, and 3-n-butenyl group; monoalkenylamino groups such as N-vinylamino group, N-1-propenylamino group, N-allylamino group, N-1-n-butenylamino group, N-2-n-butenyl amino group, and N-3-n-butenylamino group; dialkenylamino groups such as N,N-divinylamino group, N,N-di(1-propenyl)amino group, N,N-diallylamino group, N,N-di(1-n-butenyl)amino group, N,N-di(2-n-butenyl)amino group, and N,N-di(3-n-butenyl)amino group; alkenyloxy groups such as allyloxy group, 2-n-butenyloxy group, and 3-n-butenyloxy group; alkenylaminocarbonyl groups such as vinylaminocarbonyl group, 1-propenylaminocarbonyl group, allylaminocarbonyl group, 1-n-butenylaminocarbonyl group, 2-n-butenylaminocarbonyl group, and 3-n-butenylaminocarbonyl group; alkenyloxycarbonyl groups such as vinyloxycarbonyl group, 1-propenyloxycarbonyl group, allyloxycarbonyl group, 1-n-butenyloxycarbonyl group, 2-n-butenyloxycarbonyl group, and 3-n-butenyloxycarbonyl group; (meth)acryloyl group-containing groups such as acryloyl group, methacryloyl group, acryloyloxy group, methacryloyloxy group, acryloylamino group, and methacryloylamino group. Among these groups, the alkenyl group, and the (meth)acryloyl group-containing group are preferable. A number of carbon atoms in the alkenyl group is, for example, preferably 2 or more and 6 or less, and more preferably 2 or 3.

The hydrolyzable silyl group is a silyl group capable of forming a silanol group by hydrolysis. Suitable examples of the hydrolyzable silyl group include a group represented by —SiR⁰¹ₐR⁰²₃₋ₐ.

Here, R⁰¹ is a group capable of forming a silanol group by hydrolysis such as an alkoxy group and a halogen atom. As the alkoxy group, alkoxy groups having 1 or more and 4 or less carbon atoms such as methoxy group, ethoxy group, n-propyloxy group, isopropyloxy group, and n-butyloxy group are preferred. The halogen atom is preferably a chlorine atom, and a bromine atom, and more preferably a chlorine atom. R⁰² may be various organic groups not corresponding to the group capable of forming a silanol group by hydrolysis as long as the objective of the present invention is not impaired. The organic group is preferably a hydrocarbon group having 1 or more and 10 or less carbon atoms. The hydrocarbon group may be an aliphatic group or an aromatic group. The structure of the hydrocarbon group may be linear, branched, cyclic or a combination thereof. Suitable specific examples of the hydrocarbon group having 1 or more and 10 or less carbon atoms include methyl group, ethyl group, n-propyl group, isopropyl group, n-butyl group, isobutyl group, sec-butyl group, tert-butyl group, n-pentyl group, n-hexyl group, n-heptyl group, n-octyl group, n-nonyl group, n-decyl group, phenyl group, naphthalene-1-yl group, naphthalene-2-yl group, benzyl group, phenethyl group, and the like. Among these, methyl group and ethyl group are preferred. The hydrocarbon group described above may have a substituent such as an alkoxy group having 1 or more and 6 or less carbon atoms, a halogen atom, a hydroxy group, and a cyano group. a is preferably 2 or 3, and more preferably 3. In addition, in a case where a is 2 or 3, a condensation reaction is likely to occur even between the groups represented by —SiR⁰¹ₐR⁰²₃₋ₐ present adjacent to each other on the surface of the object to be treated. As a result, a network of siloxane bonds that spreads along the surface of the object to be treated is formed in the coating film that is formed using the surface treatment liquid, which makes it easy to particularly strongly bond the polymer of the polymerizable compound (A) to the surface of the object to be treated.

Suitable specific examples of the hydrolyzable silyl group represented by —SiR⁰¹ₐR⁰²₃₋ₐ include trimethoxysilyl group, triethoxysilyl group, methyldimethoxysilyl group, ethyldimethoxysilyl group, methyldiethoxysilyl group, and ethyldiethoxysilyl group.

As the unsaturated group-containing silicon compound (a2), for example, a compound represented by the following formula (a2-1) is preferred.

R⁰³—(—CO—R⁰⁴—)_{b}—R⁰⁵—SiR⁰¹ₐR⁰²₃₋ₐ (a2-1)

In the formula (a2-1), R⁰¹, R⁰² and a are as described above for the hydrolyzable silyl group. R⁰³ is an alkenyl group having 2 or more and 6 or less carbon atoms. R⁰⁴ is —O— or —NH—. R⁰⁵ is a single bond, an alkylene group having 1 or more and 10 or less carbon atoms, an aromatic hydrocarbon group having 1 or more and 10 or less carbon atoms, or a nitrogen-containing heterocyclic group having 1 or more and 10 or less carbon atoms. b is 0 or 1.

R⁰³ is an alkenyl group having 2 or more and 6 or less carbon atoms. Suitable examples of the alkenyl group include a vinyl group, 1-methylvinyl group, allyl group, 3-butenyl group, 4-pentenyl group, and 5-hexenyl group. When b is 1, R⁰³ is preferably the vinyl group or the 1-methylvinyl group. In other words, when b is 1, it is preferable that the group represented by R⁰³—CO—R⁰⁴— is an acryloyloxy group, an acryloylamino group, a methacryloyloxy group, or a methacryloylamino group.

Examples of the alkylene group as R⁰⁵ include a methylene group, an ethane-1,2-diyl group, a propane-1,3-diyl group, a butane-1,4-diyl group, a pentane-1,5-diyl group, a hexane-1,6-diyl group, a heptane-1,7-diyl group, an octane-1,8-diyl group, a nonane-1,9-diyl group, and a decane-1,10-diyl group. Examples of the aromatic hydrocarbon group as R⁰⁵ include p-phenylene group, m-phenylene group, o-phenylene group, naphthalene-2,6-diyl group, naphthalene-2,7-diyl group, biphenyl-4,4′-diyl group, biphenyl-3,4′-diyl group, and biphenyl-3,3′-diyl group.

Specific examples of the nitrogen-containing heterocyclic group include a group in which two hydrogen atoms are removed from the following nitrogen-containing heterocycles. Examples of the nitrogen-containing heterocycle include 5-membered ring such as a pyrrolidine ring, a pyrazolidine ring, an imidazolidine ring, a triazolidine ring, a tetrazolidine ring, a pyrroline ring, a pyrazolin ring, an imidazoline ring, a triazoline ring, a tetrazoline ring, a pyrrole ring, a pyrazole ring, an imidazole ring, a triazole, and a tetrazole ring; a nitrogen-containing 6-membered ring such as a piperidine ring, a piperideine ring, a piperazine ring, a triazinane ring, a tetradinane ring, a pentazinane ring, a pyridine ring, a pyridazine ring, a pyrimidine ring, a pyrazine ring, a triazine ring, a tetrazine ring, and a pentazine ring; a nitrogen-containing 7-membered ring such as an azepane ring, a diazepane ring, a triazepane ring, a tetrazepam ring, an azepine ring, a diazepine ring, and a triazepine ring; a nitrogen-containing condensed polycycle such as an indole ring, an indolenine ring, an indoline ring, an isoindole ring, an isoindolenine ring, isoindoline ring, a benzimidazole ring, an indolizine ring, a purine ring, an indolizidine ring, a benzodiazepine ring, a quinoline ring, an isoquinoline ring, a quinolizidine ring, a quinoxaline ring, a cinnoline ring, a quinazoline ring, a phthalazine ring, a naphthyridine ring, and a pteridine ring.

Suitable examples of the silane compound represented by the formula (a2-1) include a silane compound including an unsaturated group such as a vinyltrimethoxysilane, a vinyltriethoxysilane, an allyltrimethoxysilane, and an allyltrimethoxysilane; a silane compound including a (meth)acryloxy group such as 3-methacryloxypropyltrimethoxysilane, 3-methacryloxypropyltriethoxysilane, 3-methacryloxypropylmethyldimethoxysilane, 3-methacryloxypropylmethyldiethoxysilane, 3-acryloxypropyltrimethoxysilane, and 3-acryloxypropyltriethoxysilane.

(Polar Polymerizable Compound (a3))

The polar polymerizable compound (a3) has the ethylenic unsaturated double bond and the polar group selected from amino group, carboxy group, mercapto group, hydroxy group, and cyano group.

As the polar polymerizable compound (a3), a compound represented by the following formula (a3-1) is preferred.

CH₂═CR^{A1}—(R^{A2})_{c}—CO—R^{A3} (a3-1)

In the formula (a3-1), R^{A1} is hydrogen atom, or methyl group. R^{A2} is a divalent hydrocarbon group. c is 0 or 1. R^{A3} is —OH, —OR^{A4}, or —NH—R^{A4}. R^{A4} is a hydrocarbon group substituted with at least one polar group selected form the group consisting of amino group, carboxy group, mercapto group, hydroxy group, and cyano group.

In the formula (a3-1), R^{A2} is a divalent hydrocarbon group. A number of carbon atoms in the divalent hydrocarbon group is not particularly limited as long as the objective of the present invention is not impaired. The number of carbon atoms in the divalent hydrocarbon group as R^{A2} is preferably 1 or more and 20 or less, more preferably 1 or more and 12 or less, particularly preferably 1 or more and 10 or less, and most preferably 1 or more and 6 or less, since the compound represented by the formula (a3-1) is easily prepared and easily available.

The divalent hydrocarbon group as R^{A2} may be an aliphatic group, an aromatic group, or a hydrocarbon group including an aliphatic part and an aromatic part. When the divalent hydrocarbon group is an aliphatic group, the aliphatic group may be a saturated aliphatic group or an unsaturated aliphatic group. In addition, a structure of the aliphatic group may be linear, branched, cyclic, or combination of these structures.

Suitable specific examples of R^{A2} include methylene group, ethane-1,2-diyl group, ethane-1,1-diyl group, propane-1,3-diyl group, propane-1,1-diyl group, propane-2,2-diyl group, n-butane-1,4-diyl group, n-pentane-1,5-diyl group, n-hexane-1,6-diyl group, n-heptane-1,7-diyl group, n-octane-1,8-diyl group, n-nonane-1,9-diyl group, n-decane-1,10-diyl group, o-phenylene group, m-phenylene group, p-phenylene group, naphthalene-2, 6-diyl group, naphthalene-2,7-diyl group, naphthalene-1,4-diyl group, and biphenyl-4,4′-diyl group.

R^{A3} is —OH, —O—R^{A4}, or —NH—R^{A4}. R^{A4} is a hydrocarbon group substituted with at least one polar group selected form the group consisting of amino group, carboxy group, mercapto group, hydroxy group, and cyano group. The hydrocarbon group constituting a main skeleton of the group of R^{A4} may be a linear, branched, or cyclic aliphatic group, or an aromatic hydrocarbon group. A number of carbon atoms in the linear, branched, or cyclic aliphatic group is preferably 1 or more and 20 or less, and more preferably 1 or more and 12 or less. Suitable examples of the linear or branched aliphatic group include methyl group, ethyl group, n-propyl group, isopropyl group, n-butyl group, isobutyl group, sec-butyl group, tert-butyl group, n-pentyl group, isopentyl group, neopentyl group, sec-pentyl group, tert-pentyl group, n-hexyl group, n-heptyl group, n-octyl group, n-nonyl group, n-decyl group, and the like. Suitable examples of the cyclic aliphatic group include a cycloalkyl group such as cyclopropyl group, cyclobutyl group, cyclopentyl group, cyclohexyl group, cycloheptyl group, and cyclooctyl group, and a group in which one hydrogen atom is removed from a polycycloalkane such as adamantane, norbornane, isobornane, tricyclodecane, and tetracyclodecane, or a substituted polycycloalkane substituted with a C1-C4 alkyl group. Suitable examples of the aromatic hydrocarbon group include phenyl group, naphthyl group, anthranyl group, phenanthrenyl group, biphenylyl group, and the like. The aromatic hydrocarbon group may be substituted with a C1-C4 alkyl group such as methyl group, and ethyl group.

Suitable specific examples of the compound represented by the formula (a3-1) include the following compounds.

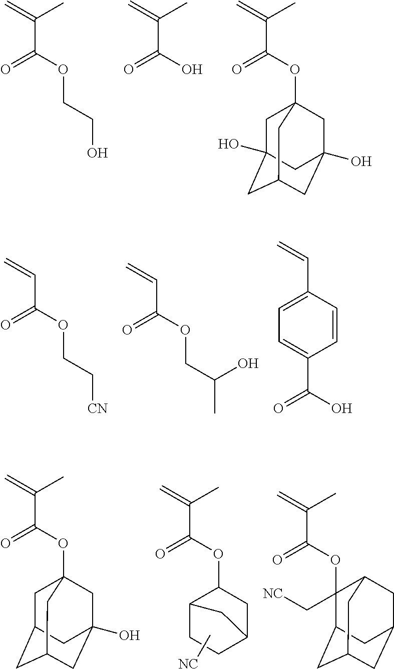

As the polar polymerizable compound (a3), a compound represented by the following formula (a3-2) is also preferred.

(R^{3a}—R^{2a})ₙ—X—R^{1a} (a3-2)

In the formula (a3-2), R^{1a} is an organic group having 1 or more ethylenic unsaturated double bond. R^{2a} is a single bond or an alkylene group having 1 or more and 10 or less carbon atoms. R^{3a} is a hydrogen atom or a polar group selected from amino group, carboxylic group, mercapto group, hydroxy group, and cyano group. n is 1 or 2. X is a nitrogen-containing heterocyclic group having valency of n+1. When n is 1, R^{3a} is the polar group. When n is 2, at least one of R^{3a}s are the polar group.

In the formula (a3-2), R^{a1} is the organic group having 1 or more ethylenic unsaturated double bond. Suitable examples of the organic group having 1 or more ethylenic unsaturated double bond include the groups represented by the following formulas (a3-2i) to (a3-2vii). In the formulas (a-2vi to a-2viii), R^{A01} is an alkenyl group having 1 or more and 10 or less carbon atoms, and R^{A02} is a hydrocarbon group having 1 or more and 10 or less carbon atoms.

—R^{a01} (a3-2i)

—NH—R^{a01} (a3-2ii)

—N(R^{a01})(R^{a02}) (a3-2iii)

—N(R^{a01})₂ (a3-2iv)

—O—R^{a01} (a3-2v)

—CO—NH—R^{a01} (a3-2vi)

—CO—O—R^{a01} (a3-2vii)

A number of carbon atoms in the alkenyl group as R^{a01} is preferably 1 or more and 6 or less, and more preferably 1 or more and 4 or less. The alkenyl group as R^{a01} may be a linear alkenyl group or a branched alkenyl group. The hydrocarbon group as R^{a02} may be an aliphatic group, an aromatic group, or a combination of an aliphatic group and an aromatic group. A number of carbon atoms of the hydrocarbon group as R^{a02} is preferably 1 or more and 6 or less, more preferably 1 or more and 4 or less, and further preferably 1 or more and 3 or less.

Suitable specific examples of the organic group having 1 or more ethylenic unsaturated double bond as R^{a1} include alkenyl groups such as vinyl group, 1-propenyl group, 2-n-propenyl group (allyl group), 1-n-butenyl group, 2-n-butenyl group, and 3-n-butenyl group; monoalkenylamino groups such as N-vinylamino group, N-1-propenylamino group, N-allylamino group, N-1-n-butenylamino group, N-2-n-butenyl amino group, and N-3-n-butenylamino group; dialkenylamino groups such as N,N-divinylamino group, N,N-di(1-propenyl)amino group, N,N-diallylamino group, N,N-di(1-n-butenyl)amino group, N,N-di(2-n-butenyl)amino group, and N,N-di(3-n-butenyl)amino group; alkenyloxy groups such as allyloxy group, 2-n-butenyloxy group, and 3-n-butenyloxy group; alkenylaminocarbonyl groups such as vinylaminocarbonyl group, 1-propenylaminocarbonyl group, allylaminocarbonyl group, 1-n-butenylaminocarbonyl group, 2-n-butenylaminocarbonyl group, and 3-n-butenylaminocarbonyl group; alkenyloxycarbonyl groups such as vinyloxycarbonyl group, 1-propenyloxycarbonyl group, allyloxycarbonyl group, 1-n-butenyloxycarbonyl group, 2-n-butenyloxycarbonyl group, and 3-n-butenyloxycarbonyl group; (meth)acryloyl group-containing groups such as acryloyl group, methacryloyl group, acryloyloxy group, methacryloyloxy group, acryloylamino group, and methacryloylamino group. Among these groups, vinyl group, allyl group, N,N-diallylamino group, allyloxy group, acryloyl group, methacryloyl group, acryloyloxy group, and methacryloyloxy group are preferred, and N,N-diallylamino group is more preferred.

In the formula (a3-2), R^{2a} is a single bond, or an alkylene group having 1 or more and 10 or less carbon atoms. A number of carbon atoms in the alkylene group is preferably 1 or more and 6 or less, more preferably 1 or more and 4 or less, and further preferably 1 or more and 3 or less. Specific examples of the alkylene group having 1 or more and 10 or less carbon atoms include methylene group, ethane-1,2-diyl group, ethane-1,1-diyl group, propane-1,3-diyl group, propane-1,1-diyl group, propane-2,2-diyl group, n-butane-1,4-diyl group, n-pentane-1,5-diyl group, n-hexane-1,6-diyl group, n-heptane-1,7-diyl group, n-octane-1,8-diyl group, n-nonane-1,9-diyl group, and n-decane-1,10-diyl group. Among these alkylene groups, methylene group, ethane-1,2-diyl group, and propane-1,3-diyl group are preferred, and methylene group, and ethane-1,2-diyl group are more preferred. In the formula (a3-2), R^{A2} is a nitrogen-containing heterocyclic group of valency of n+1. n is 1 or 2. The nitrogen-containing heterocyclic group may be an aromatic group or an aliphatic group. The nitrogen-containing heterocycle may be a monocycle or a condensed polycycle in which a monocyclic nitrogen-containing heterocycle bonds to one or more monocycles selected from a monocyclic aromatic hydrocarbon ring and a monocyclic nitrogen-containing heterocycle. In addition, the nitrogen-containing heterocycle may be a ring in which two or more rings selected from a monocyclic nitrogen-containing heterocycle and a condensed polycyclic nitrogen-containing heterocycle bond together through a single bond.

In the formula (a3-2), a group represented by R^{a1}, and a group represented by R^{3a}-R^{2a}— may bond to carbon atom as a ring-constituting atom or nitrogen atom as a ring-constituting atom on the nitrogen-containing heterocyclic group represented by X.

Examples of the nitrogen-containing heterocycle giving X include 5-membered ring such as a pyrrolidine ring, a pyrazolidine ring, an imidazolidine ring, a triazolidine ring, a tetrazolidine ring, a pyrroline ring, a pyrazoline ring, an imidazoline ring, a triazoline ring, a tetrazoline ring, a pyrrole ring, a pyrazole ring, an imidazole ring, a triazole, and a tetrazole ring; a nitrogen-containing 6-membered ring such as a piperidine ring, a piperideine ring, a piperazine ring, a triazinane ring, a tetradinane ring, a pentazinane ring, a pyridine ring, a pyridazine ring, a pyrimidine ring, a pyrazine ring, a triazine ring, a tetrazine ring, and a pentazine ring; a nitrogen-containing 7-membered ring such as an azepane ring, a diazepane ring, a triazepane ring, a tetrazepam ring, an azepine ring, a diazepine ring, and a triazepine ring; a nitrogen-containing condensed polycycle such as an indole ring, an indolenine ring, an indoline ring, an isoindole ring, an isoindolenine ring, isoindoline ring, a benzimidazole ring, an indolizine ring, a purine ring, an indolizidine ring, a benzodiazepine ring, a quinoline ring, an isoquinoline ring, a quinolizidine ring, a quinoxaline ring, a cinnoline ring, a quinazoline ring, a phthalazine ring, a naphthyridine ring, and a pteridine ring; polycycles in which 2 or more rings selected from these nitrogen-containing heterocycles are bonded via single bond(s). X derived from the nitrogen-containing heterocycle is preferably a divalent or trivalent group including a nitrogen-containing 6-membered ring, more preferably a divalent or trivalent group including a triazine ring, and further preferably a 1,3,5-triazine-2,4-diyl group and a 1,3,5-triazine-2,4,6-triyl group in view of good adhesiveness of the polymer of the polymerizable compound (A) to the surface of the object to be treated.

Suitable specific examples of the divalent or trivalent nitrogen-containing heterocyclic group as X include the following groups.

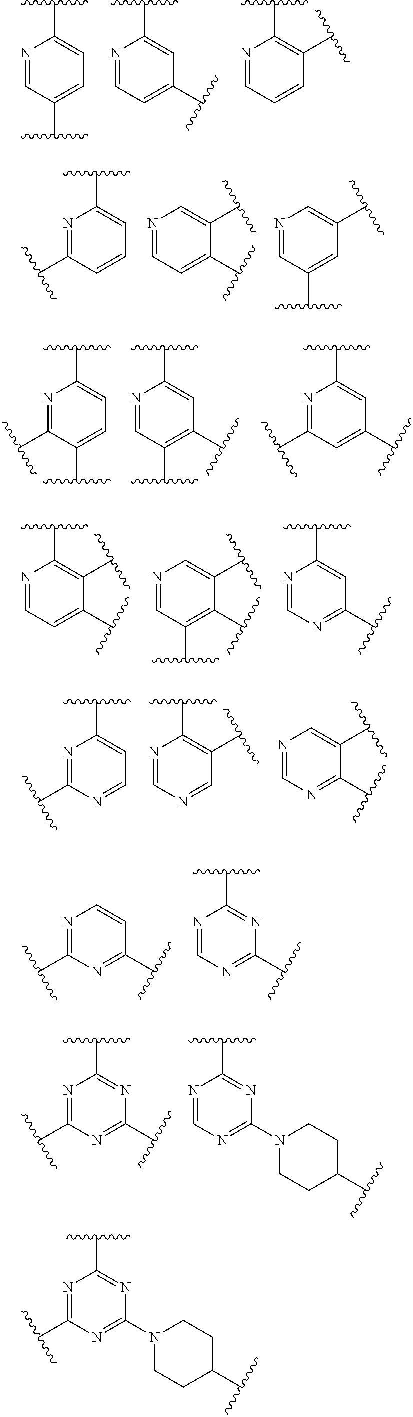

Suitable examples of the compound represented by the formula (a3-2) include the following compounds.

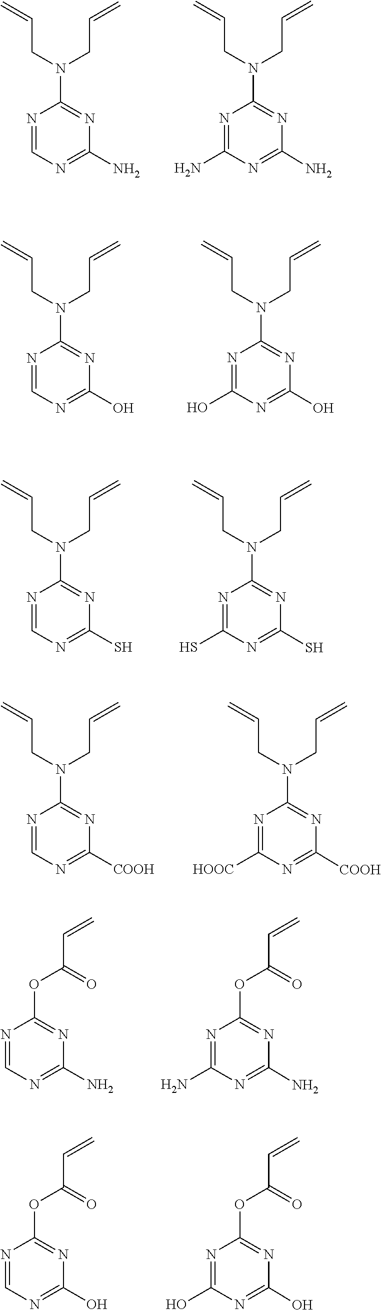

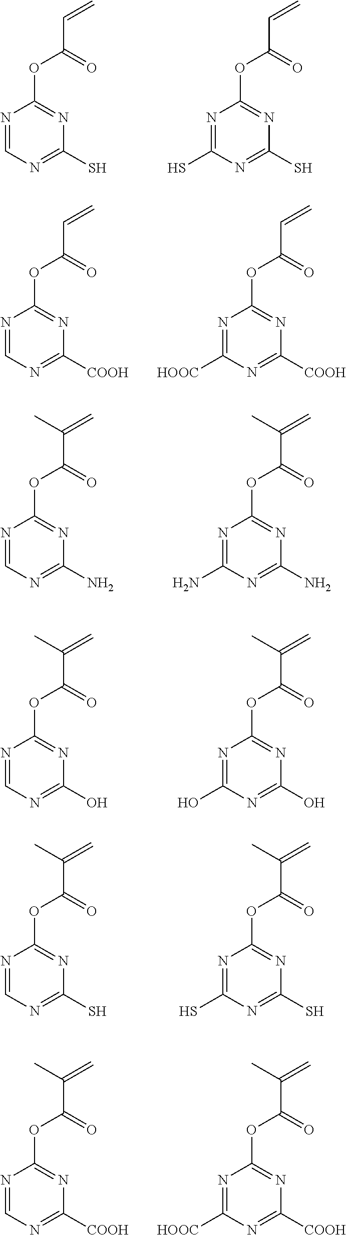

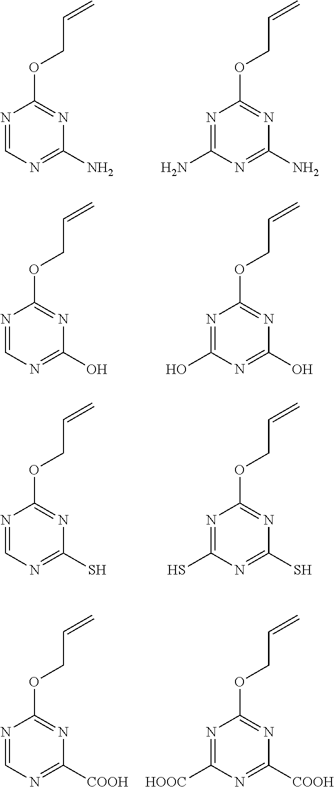

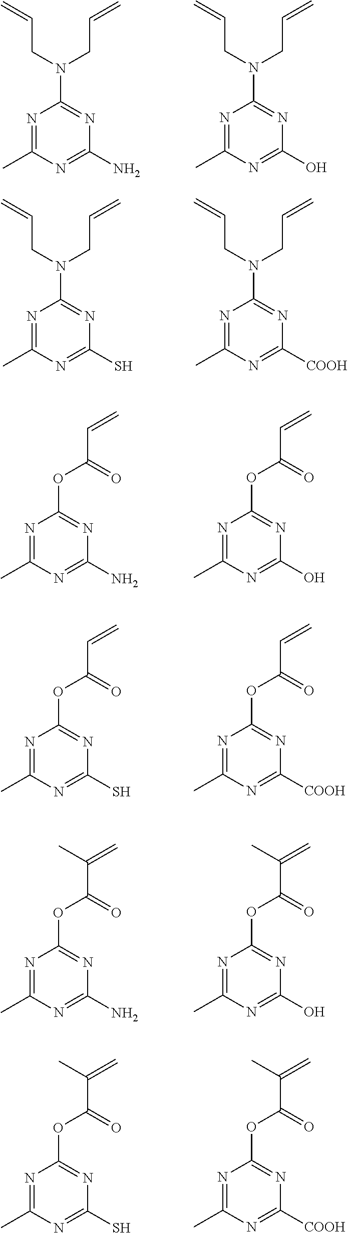

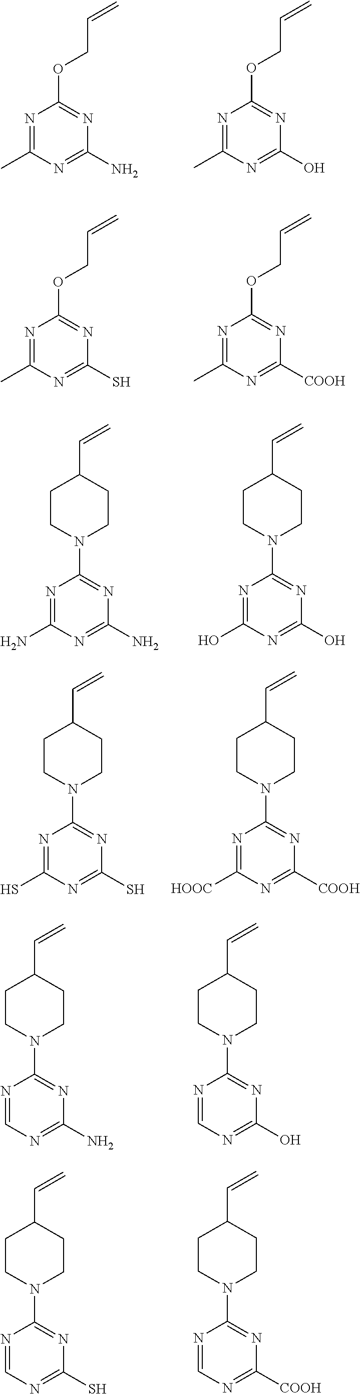

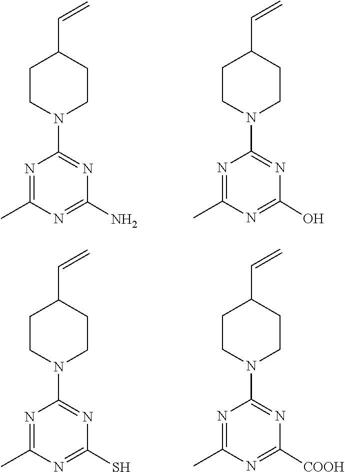

Among the above compounds, the following compounds are preferred.

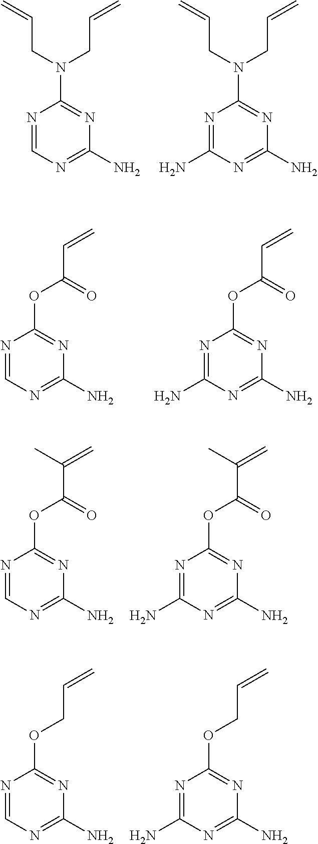

In addition, it is also preferred to use a polyfunctional compound having a hydroxyl group such as N,N′-di(meth)acryloyl-1,2-dihydroxyethylenediamine, glycerol di(meth)acrylate, pentaerythritol tri(meth)acrylate, pentaerythritol di(meth)acrylate, dipentaerythritol penta(meth)acrylate, 2-hydroxy-3-((meth)acryloyloxypropyl) (meth)acrylate, ethylene glycol diglycidyl ether di(meth)acrylate, diethylene glycol diglycidyl ether di(meth)acrylate, and diglycidyl phthalate di(meth)acrylate as the polar polymerizable compound (a3). Such a polyfunctional polar polymerizable compound (a3) is capable of improving the adhesiveness of the resin coating that is formed by the polymerization of the polymerizable compound (A) to the surface of the object to be treated not only by the action of the hydroxyl group but also by the crosslinking of molecular chains.

A ratio of a sum of a number of moles of the unsaturated group-containing silicon compound (a2) and a number of moles of the polar polymerizable compound (a3) relative to the number of moles of the polymerizable compound (A) is not particularly limited as long as the objective of the present invention is not impaired. From the viewpoint of satisfying both a good hydrophilization effect and the good adhesiveness of the resin coating to be formed to the surface of the object to be treated, The ratio of the sum of the number of moles of the unsaturated group-containing silicon compound (a2) and the number of moles of the polar polymerizable compound (a3) is preferably 1% by mole or more and 50% by mole or less, more preferably 1% by mole or more and 40% by mole or less, and even more preferably 1% by mole or more and 99% by mole or less.

[Polyfunctional Monomer (a4)]

The polymerizable compound (A) preferably include a polyfunctional monomer (a4) other than the betaine monomer (a1), the unsaturated group-containing silicon compound (a2), and the polar polymerizable compound (a3). The polyfunctional monomer (a4) is a compound having 2 or more ethylenic unsaturated double bonds and not corresponding to the betaine monomer (a1), the unsaturated group-containing silicon compound (a2), and the polar polymerizable compound (a3). In the resin coating formed by polymerization of the polymerizable compound (A), the polyfunctional monomer (a4) bridges molecular chains. By bridging, an adhesiveness of the resin coating to the surface of the object to be treated is improved.

Specific examples of the polyfunctional monomer (a4) include ethylene glycol di(meth)acrylate, diethylene glycol di(meth)acrylate, triethylene glycol di(meth)acrylate, tetraethylene glycol di(meth)acrylate, pentaethylene glycol di(meth)acrylate, hexaethylene glycol di(meth)acrylate, heptaethylene glycol di(meth)acrylate, octaethylene glycol di(meth)acrylate, nonaethylene glycol di(meth)acrylate, decaethylene glycol di(meth)acrylate, propylene glycol di(meth)acrylate, dipropylene glycol di(meth)acrylate, tripropylene glycol di (meth)acrylate, tetrapropylene glycol di(meth)acrylate, pentapropylene glycol di(meth)acrylate, hexapropylene glycol di(meth)acrylate, heptapropylene glycol di(meth)acrylate, octapropylene glycol di(meth)acrylate, nonapropylene glycol di(meth)acrylate, decapropylene glycol di(meth)acrylate, butylene glycol di(meth)acrylate, neopentyl glycol di(meth)acrylate, 1,6-hexanediol di(meth)acrylate, trimethylolpropane tri(meth)acrylate, pentaerythritol tetra(meth)acrylate, dipentaerythritol hexa(meth)acrylate, 2,2-bis(4-(meth)acryloxydiethoxyphenyl)propane, and 2,2-bis(4-(meth)acryloxypolyethoxyphenyl)propante, and the like.

A ratio of a number of moles of the polyfunctional monomer (a4) relative to the number of moles of the polymerizable compound (A) is not particularly limited as long as the objective of the present invention is not impaired. From the viewpoint that the polymer of the polymerizable compound (A) is appropriately bridged, a ratio of the polyfunctional monomer (a4) is preferably 0.5% by mole or more and 20% by mole or less, more preferably 1% by mole of more and 15% by mole or less, and even more preferably 1% by mole or more and 10% by mole or less relative to the number of moles of the polymerizable compound (A).

[Other Monomer (a5)]

The polymerizable compound (A) may include other monomer (a5) other than the betaine monomer (a1), the unsaturated group-containing silicon compound (a2), the polar polymerizable compound (a3), and the polyfunctional monomer (a4) as long as the objective of the present invention is not impaired. Other monomer (a5) is a compound having two or more ethylenic unsaturated double bonds, and not corresponding to the betaine monomer (a1), the unsaturated group-containing silicon group (a2), the polar polymerizable compound (a3), and the polyfunctional monomer (a4).

Examples of other monomer (a5) include, for example, methyl (meth)acrylate, ethyl (meth)acrylate, isopropyl (meth)acrylate, n-propyl (meth)acrylate, n-butyl (meth)acrylate, isobutyl (meth)acrylate, a tert-butyl (meth)acrylate, n-pentyl (meth)acrylate, isopentyl (meth)acrylate, phenyl (meth)acrylate, N-methyl (meth)acrylamide, N-ethyl (meth)acrylamide, N-n-propyl (meth)acrylamide, N-isopropyl (meth)acrylamide, N-n-butyl (meth)acrylamide, N-n-pentyl (meth)acrylamide, N-isopentyl (meth)acrylamide, N-phenyl (meth)acrylamide, N,N-dimethyl (meth)acrylamide, N,N-diethyl (meth)acrylamide, N,N-di-n-propyl (meth)acrylamide, N,N-di-n-butyl (meth)acrylamide, N,N-di-n-pentyl (meth)acrylamide, styrene, α-methylstyrene, β-methylstyrene, o-methylstyrene, m-methylstyrene, p-methylstyrene, chlorostyrene, methyldiallylamine, ethyldiallyamine, triallylamine, and the like.

A ratio of a number of moles of the polyfunctional monomer (a4) relative to a number of moles of the polymerizable compound (A) is not particularly limited as long as the polymerizable compound (A) includes desired amounts of the betaine monomer (a1), the unsaturated group-containing silicon compound (a2), and/pr the polar polymerizable compound (a3).

A ratio of a mass of the polymerizable compound (A) is not particularly limited, preferably 1% by mass or more and 40% by mass or less, more preferably 2% by mass or more and 20% by mass or less, and even more preferably 2% by mass or more and 15% by mass or less relative to a mass of the surface treatment liquid.

### <Thermal Polymerization Initiator (B)>

The surface treatment liquid includes a thermal polymerization initiator (B) as a component which polymerizes the polymerizable compound (A). The thermal polymerization initiator (B) is not particularly limited as long as the thermal polymerization initiator (B) is a compound capable of polymerizing the polymerizable compound (A) having an ethylenic unsaturated double bond.

As the thermal polymerization initiator (B), for example, azo polymerization initiator is exemplified. As such thermal polymerization initiator (B), 2,2′-azobis(2-methylproipionamidine) dihydrochloride, 2,2′-azobis[2-(phenylamidino)propane] dihydrochloride, 2,2′-azobis{2-[N-(4-chlorophenyl)amidino]propane} dihydrochloride, 2,2′-azobis{2-[N-(4-hydroxyphenyl)amidino]propane} dihydrochloride, 2,2′-azobis[2-(N-benzylamidino)propane] dihydrochloride, 2,2′-azobis[2-(N-allylamidino)propane] dihydrochloride, 2,2′-azobis(2-amidinopropane) dihydrochloride, 2,2′-azobis{2-[N-(4-hydroxyethyl)amidino]propane} dihydrochloride, 2,2-azobis[2-(5-methyl-2-imidazoline-2-yl)propane] dihydrochloride, 2,2-azobis[2-(2-imidazoline-2-yl)propane] dihydrochloride, 2,2-azobis[2-(4,5,6,7-tetrahydro-1H-1,3-diazepine-2-yl)propane] dihydrochloride, 2,2-azobis[2-(3,4,5,6-tetrahydropyrimidine-2-yl)propane] dihydrochloride, 2,2-azobis[2-(5-hydroxy-3,4,5,6-tetrahydropyrimidine-2-yl)propane] dihydrochloride, 2,2-azobis{2-[1-(2-hydroxyethyl)-2-imidazoline-2-yl]propane} dihydrochloride, and 2,2-azobis[2-(2-imidazoline-2-yl)propane] are exemplified. These thermal polymerization initiators (B) may be used singly or two or more thereof may be used in combination.

An amount of the thermal polymerization initiator (B) is not particularly limited as long as a polymerization reaction proceeds well. The amount of the thermal polymerization initiator (B) is preferably 0.01% by mole or more and 20% by mole or less, and more preferably 0.1% by mole or 15% by mole or less relative to the total number of moles of the polymerization compound (A).

It should be note that, the surface treatment liquid may be a two-liquid type surface treatment liquid consisting of a first liquid including the polymerizable compound (A) and the solvent (S), and a second liquid including the thermal polymerization initiator (B) and the solvent, in view of the stability over time of the surface treatment liquid. Such a two-component surface treatment liquid is used after the two liquids are mixed together immediately before a surface treatment.

### [Solvent (S)]

The surface treatment liquid includes a solvent (S). The solvent (S) may be water, an organic solvent, or an aqueous solution of the organic solvent. From the viewpoint of the solubility of the polymerizable compound (A), the safety of working for a hydrophilizing treatment, low costs and the like, the solvent (S) is preferably water. Suitable examples of the organic solvent used as the solvent (S) include an alcohol. As the alcohol, an aliphatic alcohol is preferred, and the alcohol having 1 or more and 3 or less carbon atoms is more preferred. Specifically, methanol, ethanol, n-propyl alcohol, and isopropyl alcohol (IPA) are exemplified, and methanol, ethanol, and isopropyl alcohol are preferred. The alcohols may be used singly or two or more thereof may be used in combination.

The content of water in the solvent (S) is preferably 50% by mass or more, more preferably 80% by mass or more and particularly preferably 100% by mass.

### [Other Component]

The surface treatment liquid may include various additives as long as the objective of the present invention is not impaired.

Examples of such additives include an antioxidant, an ultraviolet absorber, a colorant, a defoamer, a viscosity modifier and the like. A content of these additives is appropriately determined in consideration of an amount in which these additives are ordinarily used.

### «Hydrophilizing Treatment Method»

The hydrophilizing treatment method includes:
applying the aforementioned surface treatment liquid to form a coating film on the surface of an object to be treated, and heating the coating film.

Here, there is no need to apply the surface treatment liquid uniformly to the entire surface of the object to be treated, which is supposed to be hydrophilized, as long as the surface of the object to be treated is hydrophilized as much as desired. The hydrophilizing treatment method preferably further includes rinsing the surface of the object to be treated with a rinse liquid after the heating of the coating film.

Herein, forming the coating film on the surface of the object to be treated by applying the surface treatment liquid is also described as “application step”. Heating the coating film is also described as “heating step”. Rinsing the surface of the object to be treated with a rinse liquid after the heating of the coating film is also described as “rinsing step”. Hereinafter, the application step, the heating step and the rinsing step will be described in detail.

### <Application Step>

In the application step, the coating film is formed by applying the aforementioned surface treatment liquid on the surface of the object to be treated. The application method is not particularly limited. Specific examples of the application method include a spin coating method, a spraying method, a roller coating method, an immersion method and the like. In a case where the object to be treated is a substrate, the spin coating method is preferable as the application method since it is easy to evenly form a coating having a uniform film thickness on the surface of the substrate.

The material of the surface of the object to be treated to which the surface treatment liquid is applied is not particularly limited and may be an organic material or an inorganic material. Examples of the organic material include a variety of resin materials such as a polyester resin such as a PET resin or a PBT resin, a variety of nylons, a polyimide resin, a polyamide-imide resin, a polyolefin such as polyethylene or polypropylene, polystyrene, a (meth)acrylic resin, a cycloolefin polymer (COP), a cycloolefin copolymer (COC) and a silicone resin (for example, polyorganosiloxane such as polydimethylsiloxane (PDMS)). In addition, a photosensitive resin component that is included in a variety of resist materials as well as an alkali-soluble resin component are also preferable as the organic material. Examples of the inorganic material include glass, silicon and a variety of metals such as copper, aluminum, iron and tungsten. The metals may be alloys.

The shape of the object to be treated is not particularly limited. The object to be treated may be flat or a three-dimensional shape, for example, a spherical shape or a columnar shape.

The object to be treated may be exposed to a chemical such as a detergent, and there is a concern that the exposure to the chemical may degrade the hydrophilicity of the coating formed on the object to be treated. However, the use of the aforementioned surface treatment liquid makes it possible to suppress the deterioration of the hydrophilicity in a case where the surface-treated surface has come into contact with a variety of chemicals. Therefore, when articles consisting of glasses or transparent resins included in the object to be treated, which is often exposed to the chemicals such as the detergent, such as windows, mirrors, furniture, optical devices (for example, devices equipped with lens) are used as the object to be treated, resistance to chemicals with respect to hydrophilicity is significantly achieved.

After the surface treatment liquid is applied to the surface of the object to be treated, at least part of the solvent (S) may be removed from the coating film consisting of the surface treatment liquid as necessary by a well-known drying method.

The film thickness of the coating film that is formed in the application step is not particularly limited. The thickness of the coating film that is formed in the application step is, for example, preferably 1 μm or less, more preferably 300 nm or less and even more preferably 100 nm or less.

In the application step, the thickness of the coating film can be adjusted by adjusting a solid content of the surface treatment liquid, conditions for application, and the like.

### <Heating Step>

In heating step, the coating film formed in the application step is heated. The heating makes the polymerizable compound (A) that is included in the coating film polymerize due to the action of the thermal polymerization initiator (B) to form a resin coating film that strongly bonds to the surface of the object to be treated.

Heating conditions are not particularly limited as long as the polymerizable compound (A) polymerizes as much as desired and the object to be treated does not deteriorate or deform. Heating temperature is, for example, preferably 30° C. or more and 300° C. or less and more preferably 40° C. or more and 250° C. or less. Heating time is, for example, preferably 1 minute or longer and 6 hours or shorter, more preferably 3 minutes or longer and 60 minutes or shorter, and even more preferably 5 minutes or longer and 30 minutes or shorter.

### <Rinsing Step>

In the rinsing step, the surface of the object to be treated is rinsed with a rinse liquid after the heating of the coating film. By rinsing, the coating film formed on the object to be treated can be thinner. The rinse liquid is not particularly limited as long as the coating film with desired thickness can be formed. As the rinse liquid, water, an organic solvent and an aqueous solution of an organic solvent can be used. As the rinse liquid, water is preferred. Method for rinsing the coating film is not particularly limited. Typically, rinse is carried out by contacting the rinse liquid to the coating film in the same manner as the aforementioned method of application.

The film thickness of the coating film after the rinsing is, for example, preferably 10 nm or less, more preferably 0.1 nm or more and 10 nm or less, still more preferably 0.1 nm or more and 8 nm or less, far still more preferably 0.5 nm or more and 5 nm or less and particularly preferably 0.5 nm or more and 3 nm or less.

The thickness of the coating film can be adjusted by adjusting a solid content of the surface treatment liquid, conditions for application, an amount of the rinse liquid, a type of the rinse liquid, a temperature of the rinse liquid, and the like.

After the rinsing, the object to be treated is dried as necessary and then preferably used in a variety of uses.

### EXAMPLES

Hereinafter, the present invention will be more specifically described by showing examples, but the scope of the present invention is not limited to these examples.

### Examples 1 to 9 and Comparative Examples 1 to 4

In Examples, the following A1-1 and A1-2 in amounts shown in Table 1 were used as the betaine monomer (a1) described above. In Examples, the following A2-1 in amounts shown in Table 1 was used as the unsaturated group-containing silicon compound (a2). In Examples and Comparative Examples, the following A3-1 and A3-2 in amounts shown in Table 1 were used as the polar polymerizable compound (a3). In Examples, nonaethylene glycol diacrylate (A4-1) in amounts shown in Table 1 was used as the polyfunctional monomer (a4). In Comparative Examples, the following A5-1, A5-2, and A5-3 were used as other monomer (a5).

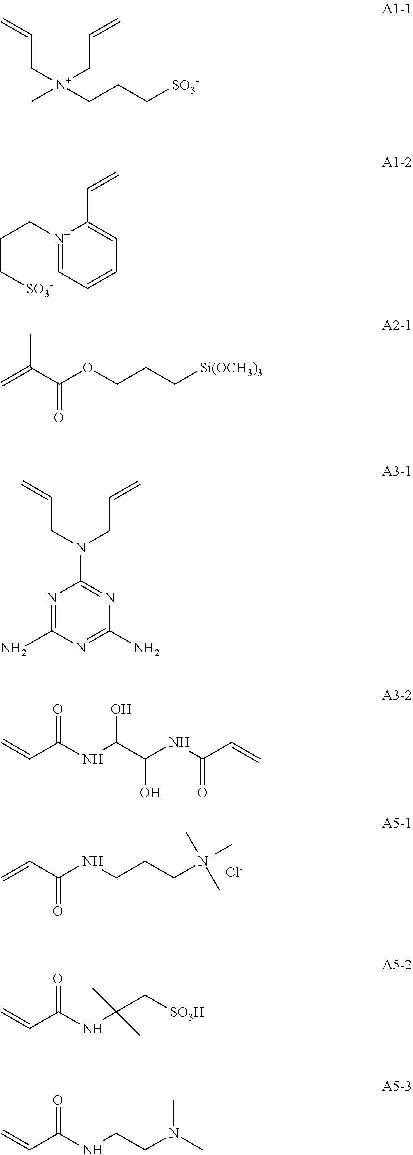

In Examples and Comparative Examples, 2,2′-azobis(2-methylpropionamidine) dihydrochloride was used in amounts shown in Table 1 as a thermal polymerization initiator (B).

The polymerizable compound (A) was dissolved in water according to the types and amounts shown in Table 1 such that the solid content concentration reached 10% by mass, and then the thermal polymerization initiator (B) was added to the obtained solutions in the amounts shown in Table 1, thereby obtaining surface treatment liquids of Examples 1 to 9 and Comparative Examples 2 to 3.

In Comparative Example 1, a copolymer of 99% by mole of the above A1-1 and 1% by mole of the above A2-1 is dissolved in water such that the solid content concentration reached 10% by mass to obtain surface treatment liquid.

Following evaluations were carried out using the obtained surface treatment liquids.

### <Contact Angle of Water>

The surface treatment liquid of each of Examples and Comparative Examples was applied onto a silicon wafer by spin coating under conditions of 1000 rpm and 60 seconds, and the wafer was heated at 100° C. for 10 minutes. Next, the surface of the wafer was washed with water to form a coating film with a thickness of monoatomic layer level composed of a resin that was a copolymer of the polymerizable compound (A) on the wafer. A pure water drop (2.0 μL) was added dropwise to the surface-treated surface of the silicon wafer using DropMaster 700 (manufactured by Kyowa Interface Science Co., Ltd.), and the contact angle of the water was measured as a contact angle after 10 seconds from the dropwise addition. Average value of the contact angle at three points on the silicon wafer was shown in Table 1. It should be noted the contact angle of the water on the untreated silicon wafer is 13.8°.

### <Measurement of Film Thickness>

A film thickness of the coating film formed in measurement of the contact angle of water was measured with a spectroscopic ellipsometry.

### <Chemical Solution Resistance>

The silicon wafer surface-treated by the same method as for the measurement of the contact angle of water was immersed in an aqueous solution of sodium dodecyl sulfate at a concentration of 1% by mass, which is an anionic chemical solution, for 1 minute. Thereafter, the surface of the silicon wafer was washed with pure water by showering for 1 minute. The contact angle of water on the surface-treated surface of the washed silicon wafer was measured according to the above-described method. Contac angles of the water measured are shown in Table 1.

### <S2s Intensity>

The surface of the silicon wafer surface-treated by the same method as for the measurement of the contact angle of water was measured by X-ray photoelectron spectroscopy (XPS) to determine the intensity of the S2s peak, which is attributed to the sulfur atoms included in the sulfonic acid anion group or the sulfonic acid group possessed by the resin. The higher the value of the intensity of S2s peak, the better the resin is bonded to the substrate. It should be noted that the intensity of the S2s peak was not measured with respect to Comparative Example 2 and Comparative Example 4 in which a polymerizable compound having the sulfonic acid anion group or the sulfonic acid group.

TABLE 1

| | | Examples | | | | | | |
|---|---|---|---|---|---|---|---|---|
| | | 1 | 2 | 3 | 4 | 5 | 6 | 7 |
| Polymerizable | A1-1 | 2.24 | 2.24 | — | 2.24 | 2.24 | — | 1.12 |
| compound (A) | A1-2 | — | — | 2.24 | — | — | 2.24 | 1.12 |
| (mmol) | A2-1 | — | 0.12 | 0.12 | 0.06 | 0.12 | 0.12 | — |
| | A3-1 | 0.12 | — | — | 0.06 | — | — | 0.12 |
| | A3-2 | — | — | — | — | 0.12 | — | — |
| | A4-1 | — | — | — | — | — | 0.12 | — |
| | A5-1 | — | — | — | — | — | — | — |
| | A5-2 | — | — | — | — | — | — | — |
| | A5-3 | — | — | — | — | — | — | — |

| | | | | | | | |
|---|---|---|---|---|---|---|---|
| Thermal polymerization | 0.24 | 0.24 | 0.24 | 0.24 | 0.25 | 0.25 | 0.24 |
| initiator (B) | | | | | | | |
| (mmol) | | | | | | | |
| Contact angle of water | 4.3 | 4.2 | 4.3 | 5.3 | 4.3 | 5.1 | 4.5 |
| (°) | | | | | | | |
| Film thickness (nm) | 4.2 | 4.3 | 4.5 | 4.4 | 5.2 | 4.9 | 4.3 |
| Chemical solution | 4.4 | 4.4 | 4.2 | 5.5 | 4.4 | 5.1 | 4.4 |
| resistance (°) | | | | | | | |
| S2s intensity (Counts) | 12305 | 11045 | 12381 | 12451 | 13211 | 13241 | 12452 |

| | | Examples | | Comparative Examples | | | |
|---|---|---|---|---|---|---|---|
| | | 8 | 9 | 1 | 2 | 3 | 4 |
| Polymerizable | A1-1 | 2.24 | 2.24 | — | — | — | — |
| compound (A) | A1-2 | — | — | — | — | — | — |
| (mmol) | A2-1 | 0.02 | — | — | — | — | — |
| | A3-1 | — | — | — | — | — | — |
| | A3-2 | — | 0.12 | — | 0.12 | 0.12 | 0.12 |
| | A4-1 | — | — | — | — | — | — |
| | A5-1 | — | — | — | 2.24 | — | — |
| | A5-2 | — | — | — | — | 2.24 | — |
| | A5-3 | — | — | — | — | — | 2.24 |

| | | | | | | |
|---|---|---|---|---|---|---|
| Thermal polymerization | 0.23 | 0.24 | — | 0.24 | 0.24 | 0.24 |
| initiator (B) | | | | | | |
| (mmol) | | | | | | |
| Contact angle of water | 4.4 | 6.5 | 8.7 | 6.5 | 4.5 | 15.1 |
| (°) | | | | | | |
| Film thickness (nm) | 4.5 | 4.6 | 2.2 | 4.6 | 4.6 | 4.8 |
| Chemical solution | 4.3 | 6.1 | 9.1 | 74.2 | 56.1 | 71.2 |
| resistance (°) | | | | | | |
| S2s intensity (Counts) | 12198 | 12331 | 6752 | — | 12414 | — |

According to Examples 1 to 9, form the measurement results of S2s intensity, it is found that a coating film consisting of a polymer of the polymerizable compound (A) is formed in a state that the coating film adheres well to the surface of the object to be treated by heating the object to be treated after applying the aforementioned surface treatment liquid including the polymerizable compound (A) including the betaine monomer (a1), the unsaturated group-containing silicon compound (a2) and/or the polar polymerizable compound (a3), and the thermal polymerization initiator (B) onto the surface of the object to be treated. In addition, from the results of a test for the chemical solution resistance regarding Examples 1 to 9, it is found that the hydrophilization effect hardly decreases, even if the surface-treated surface comes into contact with an ionic chemical liquid such as a solution of sodium dodecyl sulfate, when surface treatment is carried out using the surface treatment liquid including the betaine monomer (a1) as the polymerizable compound (A). On the other hand, according to Comparative Example 1, from the measurement result of the S2s intensity, it is found that it is difficult for the resin to adhere well to the surface of the object to be treated, even if surface treatment is carried out using the surface treatment liquid including the resin including the constituent unit derived from the betaine monomer (a1) and the constituent unit derived from the unsaturated group-containing silicon compound (a2). In addition, according to Comparative Examples 2 to 4, it is found that the surface of the object to be treated is hydrophilized well immediately after the surface treatment, but the hydrophilization effect significantly decreases by contact of the chemical liquid such as sodium dodecyl sulfonate solution to the surface-treated surface of the object to be treated, when the surface treatment is carried out using the surface treatment liquid not including the betaine monomer as the polymerizable compound (A).

1. A surface treatment liquid comprising a polymerizable compound (A), a thermal polymerization initiator (B), and a solvent (S),
wherein the polymerizable compound (A) comprises a betaine monomer (a1) having a group comprising an ethylenic unsaturated double bond, an anionic group, and a cationic group, an unsaturated group-containing silicon compound (a2) having a group comprising an ethylenic unsaturated double bond, and a hydrolyzable silyl group, and/or a polar polymerizable compound (a3) having an ethylenic unsaturated double bond, and a polar group selected from amino group, carboxylic group, mercapto group, hydroxy group, and cyano group.

2. The surface treatment liquid according to claim 1, wherein the cationic group is a quaternary nitrogen cation group.

3. The surface treatment liquid according to claim 1, wherein the anionic group is a sulfonic acid anion group, a phosphonic acid anion group, or a carboxylic acid anion group.

4. The surface treatment liquid according to claim 1, wherein a ratio of a number of moles of the betaine monomer (a1) is 50% by mole or more and 99% by mole or less relative to a number of moles of the polymerizable compound.

5. The surface treatment liquid according to claim 1, wherein the unsaturated group-containing silicon compound (a2) is a (meth)acrylic acid ester having an alkyl group substituted with the hydrolyzable silyl group.

6. The surface treatment liquid according to claim 1, wherein the polar polymerizable compound (a3) is a compound represented by formula (a-3):
(R^{3a}—R^{2a})ₙ—X—R^{1a} (a-3)
wherein, in the formula (a-3), R^{1a} is an organic group having 1 or more ethylenic unsaturated double bond, R^{2a} is a single bond or an alkylene group having 1 or more and 10 or less carbon atoms, R^{3a} is hydrogen atom or a polar group selected from amino group, carboxylic group, mercapto group, hydroxy group, and cyano group, n is 1 or 2, X is a nitrogen-containing heterocyclic group of valency of n+1, when n is 2, at least one of R^{3a}s is the polar group.

7. The surface treatment liquid according to claim 1, wherein the polymerizable compound (A) comprises a polyfunctional monomer (a4) other than the betaine monomer (a1), the unsaturated group-containing silicon compound (a2), and the polar polymerizable compound (a3).

8. The surface treatment liquid according to claim 1, wherein a content of the polymerizable compound (A) in the surface treatment liquid is 2% by mass or more and 50% by mass or less.

9. The surface treatment liquid according to claim 1, wherein the solvent (S) comprises water.

10. A hydrophilizing treatment method comprising:
forming a coating film on a surface of an object to be treated by applying the surface treatment liquid according to claim 1, and
heating the coating film.

11. The hydrophilizing treatment method according to claim 10, further comprising rinsing the surface of the object to be treated with a rinse liquid after heating of the coating film.
